(19) United States
(12) Patent Application Publication
(10) Pub. No.: US 2007/0046363 A1
(43) Pub. Date: Mar. 1, 2007

(54) Method and apparatus for generating a variable output voltage from a bandgap reference

(76) Inventor: Toru Tanzawa, Tokyo (JP)

Correspondence Address: TRASK BRITT, P.C./ MICRON TECHNOLOGY, P.O. BOX 2550, SALT LAKE CITY, UT, 84110, US

(21) Appl. No.: 11/215,803

(22) Filed: Aug. 29, 2005

(30) Foreign Application Priority Data
Aug. 26, 2005 (JP) 2005-246231

(51) Int. Cl. G05F 1/10

(52) U.S. Cl. 327/539

(57) ABSTRACT

A method and apparatus for generating a variable output voltage from a voltage reference circuit is disclosed. A voltage reference circuit includes a first voltage generator configured for generating a first voltage signal having a negative temperature coefficient and a second voltage generator configured for generating a second voltage signal having a positive temperature coefficient. The voltage reference circuit further includes a current generator configured for supplying a reference current to the first voltage generator and the second voltage generator. A comparator configured for comparing the first voltage signal to the second voltage signal generates a comparison result to modify the reference current with a current change related to the result of the comparison. Finally, the voltage reference circuit also includes an output terminal operably coupled to the current generator, wherein the output terminal comprises a voltage that is a voltage differential above a bandgap voltage and substantially independent of temperature change.

### BACKGROUND OF THE INVENTION

### Field of the Invention

The present invention relates to voltage reference circuits. More specifically, the present invention relates to circuits and methods for generating a variable reference voltage from a bandgap reference.

Many systems that manipulate and generate analog and digital signals need precise, stable voltage and current references defining bias points for these systems. In many cases, these voltage references must be in addition to and independent from a supply voltage for the circuit. In Dynamic Random Access Memories (DRAM), as well as other semiconductor devices, some of these applications are in areas such as sense amplifiers, input signal level sensors, phase locked loops, delay locked loops, and various other analog circuits.

Many techniques exist for generating these voltage references. Traditional bias generation techniques vary from a simple resistor voltage divider, to the voltage drop generated by forward biased diodes, to reverse-biased Zener diodes, to more precise bandgap reference circuits. These reference voltages may typically need to be independent from a source supply voltage and relatively constant across temperature variations.

A voltage reference may be created from a traditional and simple voltage divider circuit using resistors in series. Unfortunately, the resultant reference voltage is a function of the supply voltage and controlling the precision of the resistors may be difficult. Voltage dividers are, therefore, not an adequate solution when supply independence is required.

The voltage drop across a diode may be used to generate a voltage supply independent reference voltage. However, a diode voltage drop is temperature dependent and inadequate for systems where the reference voltage must be substantially constant over a wide range of temperatures.

Complementary MOS (CMOS) circuits are often used to generate supply independent reference voltages using transistor threshold voltages (Vt) to generate a reference. These circuits typically have the advantage of being small in area, relatively simple, and relatively independent from the supply voltage. However, as with diode references, Vt referenced bias sources typically vary with changes in temperature.

Bandgap reference sources are quite flexible and may generate reference voltages that are substantially voltage supply independent and substantially temperature independent. However, conventional bandgap reference circuits generate a voltage at the bandgap of silicon, or integer multiples of the bandgap voltage.

A circuit diagram of a conventional bandgap reference 10 is shown in FIG. 1. The bandgap reference includes a p-channel transistor 12 configured as a current source, an amplifier 15, two diode connected bipolar transistors (28 and 38), and resistors (22, 32, and 36). The bipolar transistors (28 and 38) are configured with junction areas of relative size such that the first bipolar transistor 28 has a P—N junction area with a relative size of one, and the second bipolar transistor 38 has a P—N junction area that is N times the size of bipolar transistor 28.

Generally, a bandgap reference is derived from the principal that two diodes of different sizes, but with the same emitter current, will have different current densities and, as a result, slightly different voltage drops across the P—N junction. Furthermore, P—N junctions have a negative temperature coefficient wherein changes in the voltage drop across the P—N junction are inversely proportional to changes in temperature. In other words, as temperature rises, the voltage drop across a P—N junction falls. For example, for silicon, the voltage drop across a P—N junction is inversely proportional to temperature changes at about −2.2 mV/° C.

In operation, the feedback on the amplifier 15 operates to develop a steady state wherein the inverting input node 20 and the non-inverting input node 30 are maintained at substantially the same voltage potential. If the inputs are not at the same potential, the amplifier 15 acts to reduce or increase the voltage on a feedback node 18. In turn, the voltage on the feedback node 18 will increase or decrease the current through the p-channel transistor 12. Thus, for a circuit wherein resistors 22 and 32 have the same value, the voltage drop across the first bipolar transistor 28 is equal to the combination of the voltage drop across the second bipolar transistor 38 and the voltage drop across resistor 36. As a result, the voltage drop across resistor 36 represents the difference between the voltage drop across the first transistor 28 and the voltage drop across the second transistor 38. This difference generally may be referred to as ΔV_{be} indicating that it represents the difference in voltage drop between the two bipolar transistors 28 and 38. ΔV_{be} may also be referred to as a voltage that is Proportional to Absolute Temperature (PTAT) because the voltage adjusts in proportion to temperature change with a positive temperature coefficient substantially opposite to the negative temperature coefficient of the first bipolar transistor 28 such that the output signal 40 remains substantially temperature independent.

Due to the negative temperature coefficient for diodes, as temperature rises, the V_{be} of the first bipolar transistor 28 decreases at a higher rate than the V_{be} decrease of the second bipolar transistor 38. Consequently, to keep the feedback loop in a steady state, the ΔV_{be} across resistor 36, has a direct temperature correlation (i.e., voltage change increases as temperature increases). When in the steady state, the circuit generates a resulting output signal 40 substantially equal to the bandgap voltage of silicon, which is about 1.25 volts.

FIG. 2 illustrates the negative temperature coefficient 25 of the first bipolar transistor 28, the positive temperature coefficient 35 resulting from the V_{PTAT}, and the substantially temperature independent output voltage 45.

A circuit diagram of another conventional bandgap reference 60 is shown in FIG. 3. The bandgap reference 60 of FIG. 3 may be configured to generate a reference voltage that is twice the bandgap voltage. The bandgap reference 60 includes a p-channel transistor 62 configured as a current source, an amplifier 65, four diode connected bipolar transistors (78, 79, 88, and 89), and resistors (72, 82, and 86). In this circuit, bipolar transistor 78 and bipolar transistor 79 are connected in series to create two diode voltage drops. Similarly, bipolar transistor 88 and bipolar transistor 89 are connected in series to create two diode voltage drops. The area of the P—N junctions of bipolar transistors 88 and 89 are larger, such as, for example, N times as large as the area of the P—N junctions of bipolar transistors 78 and 79.

The feedback for the circuit of FIG. 3 operates similar to that of the circuit of FIG. 1. As a result, the voltage drop across resistor 86 is set to be about the difference between the two-diode voltage drop across bipolar transistors 78/79 and the two-diode voltage drop across bipolar transistors 88/89. The resulting voltage on the output signal 90 is about twice the silicon bandgap voltage (i.e., about 2.5 volts). This circuit may be expanded by using more than two transistors in series to create voltage references that are integer multiples of the bandgap voltage.

However, there is a need for a reference voltage generator that is substantially temperature independent, substantially supply voltage independent, and that may generate a variable output above the bandgap voltage that is not an integer multiple of the silicon bandgap voltage.

### BRIEF SUMMARY OF THE INVENTION

The present invention in a number of embodiments includes methods and apparatuses for generating a reference voltage that is substantially temperature independent, substantially supply voltage independent, and at a voltage output above a bandgap voltage.

In one embodiment of the invention, a voltage reference circuit includes a first voltage generator configured for generating a first voltage signal having a negative temperature coefficient. The voltage reference circuit further includes a current generator configured for supplying a reference current having a positive temperature coefficient and an offset current, wherein the reference current is related to a voltage of the first voltage signal. The voltage reference circuit further includes a first resistance element operably coupled between the first voltage generator and the current generator. Finally, the voltage reference circuit includes an output signal operably coupled the current generator, wherein the output signal comprises a voltage that is a voltage offset above a bandgap voltage and substantially independent of a temperature change.

In another embodiment of the invention, a voltage reference circuit comprises an amplifier having a first input, a second input, and a comparison result. The voltage reference circuit further includes a current source configured for sourcing a current related to a voltage of the comparison result, wherein an output of the current source is configured as an output signal. The voltage reference circuit further includes a first resistance element operably coupled between the output signal and the first input and a first P—N junction element operably coupled in a forward bias direction between the first input and a ground. The voltage reference circuit further includes a second resistance element operably coupled between the output signal and the second input, a third resistance element operably coupled to the second input, and a second P—N junction element operably coupled in series with the third resistance element, in a forward bias direction, between the third resistance element and the ground. In addition, the voltage reference circuit includes a fourth resistance element operably coupled between the second input and the ground.

In another embodiment of the invention, a voltage reference circuit comprises an amplifier having a first input, a second input, and a comparison result configured as an output signal. The voltage reference circuit further includes a first resistance element operably coupled between the output signal and the first input and a first P—N junction element operably coupled in a forward bias direction between the first input and a ground. The voltage reference circuit further includes a second resistance element operably coupled between the output signal and the second input, a third resistance element operably coupled to the second input, and a second P—N junction element operably coupled in series with the third resistance element, in a forward bias direction, between the third resistance element and the ground. In addition, the voltage reference circuit includes a fourth resistance element operably coupled between the second input and the ground.

Another embodiment of the invention comprises a method of generating a reference voltage. The method includes generating a reference current. The method also includes generating a first voltage signal related to a first portion of the reference current, wherein the first voltage is inversely related to a temperature change, and generating a second voltage signal related to a second portion of the reference current, wherein the second voltage is directly related to the temperature change. The method also includes comparing the first voltage signal to the second voltage signal to generate a comparison result and modifying the reference current with a current change related to the comparison result. Finally, the method also includes providing an output voltage related to the second voltage, wherein the output voltage is a voltage offset above a bandgap voltage and substantially independent of the temperature change.

Another embodiment of the present invention comprises a semiconductor device including at least one voltage reference circuit according to an embodiment of the invention described herein.

Another embodiment of the present invention comprises at least one semiconductor device fabricated on a semiconductor wafer, wherein the at least one semiconductor device includes at least one voltage reference circuit according to an embodiment of the invention described herein.

Yet another embodiment in accordance with the present invention comprises an electronic system including at least one input device, at least one output device, at least one processor, and at least one memory device. The at least one memory device includes at least one voltage reference circuit according to an embodiment of the invention described herein.

### BRIEF DESCRIPTION OF THE SEVERAL VIEWS OF THE DRAWINGS

FIG. 1 is a circuit diagram of a conventional bandgap reference circuit;

FIG. 2 is a graphical illustration of various voltages in the bandgap reference circuit of FIG. 1;

FIG. 3 is a circuit diagram of a conventional bandgap reference circuit for generating a voltage reference that is an integer multiple of the bandgap voltage;

FIG. 4 is a circuit model of an embodiment of the present invention for generating a variable output voltage above the bandgap voltage;

FIG. 5A is a circuit diagram of an embodiment of the present invention for generating a variable output voltage above the bandgap voltage;

FIG. 5B is a circuit diagram of an embodiment of the present invention for generating a variable output voltage above the bandgap voltage and a variable output current;

FIG. 6A is a graphical illustration of various voltages according to the FIG. 5A embodiment;

FIG. 6B is a graphical illustration of various currents according to the FIG. 5A embodiment;

FIG. 7A is circuit diagram of another embodiment of the present invention for generating a variable output voltage above the bandgap voltage;

FIG. 7B is circuit diagram of another embodiment of the present invention for generating a variable output voltage above the bandgap voltage and a variable output current;

FIG. 8 is a semiconductor wafer containing a plurality of semiconductor devices containing a voltage reference circuit according to the present invention; and

FIG. 9 is a computing system diagram showing a plurality of semiconductor memories containing a voltage reference circuit according to the present invention.

### DETAILED DESCRIPTION OF THE INVENTION

The present invention in a number of embodiments includes methods and apparatuses for generating a reference voltage that is substantially temperature independent, substantially supply voltage independent, and at a voltage output above a bandgap voltage.

Some circuits in this description may contain a well-known circuit configuration known as a diode-connected transistor. A diode-connected transistor is formed when the gate and drain of a Complementary Metal Oxide Semiconductor (CMOS) transistor are connected together, or when the base and collector of a bipolar transistor are connected together. For example, in the circuit shown in FIG. 1, the bipolar transistors 28 and 38 are connected in a diode configuration. When connected in this fashion the transistor operates with voltage to current properties similar to a p-n junction diode.

Historically, voltage references corresponding to the bandgap voltage of silicon have been defined using the voltage from the base to emitter (V_{be}) of a bipolar junction transistor. However, any device creating a P—N junction may be used rather than a bipolar transistor, such as, for example a conventional diode or a CMOS device connected in a diode configuration. While the bandgap voltage may be obtained from a variety of devices in the various embodiments of the invention, suitable devices used to generate the bandgap voltage may be generally referred to as diodes, P—N junction elements, diode-connected CMOS transistors, and diode connected bipolar transistor. In addition, the voltage drop generated by any of these devices may be referred to using the historical V_{be} nomenclature.

FIG. 4 illustrates a circuit model 90, to show the theory of generating a reference voltage above the bandgap voltage that is substantially independent from temperature change. A current generator 92 is coupled to the series combination of a resistance element 94 and a negative temperature coefficient element 96. The resistance element 94 provides a Proportion to Absolute Temperature (PTAT) voltage (also referred to as a positive temperature coefficient) to balance the negative temperature coefficient element 96. The current generator 92 provides a reference current I_{ptco} (Positive Temperature Coefficient with an Offset Current) different from that of a conventional bandgap reference circuit such that the voltage on an output node 98 may be selected to be at a voltage higher than the bandgap voltage, as is explained more fully below.

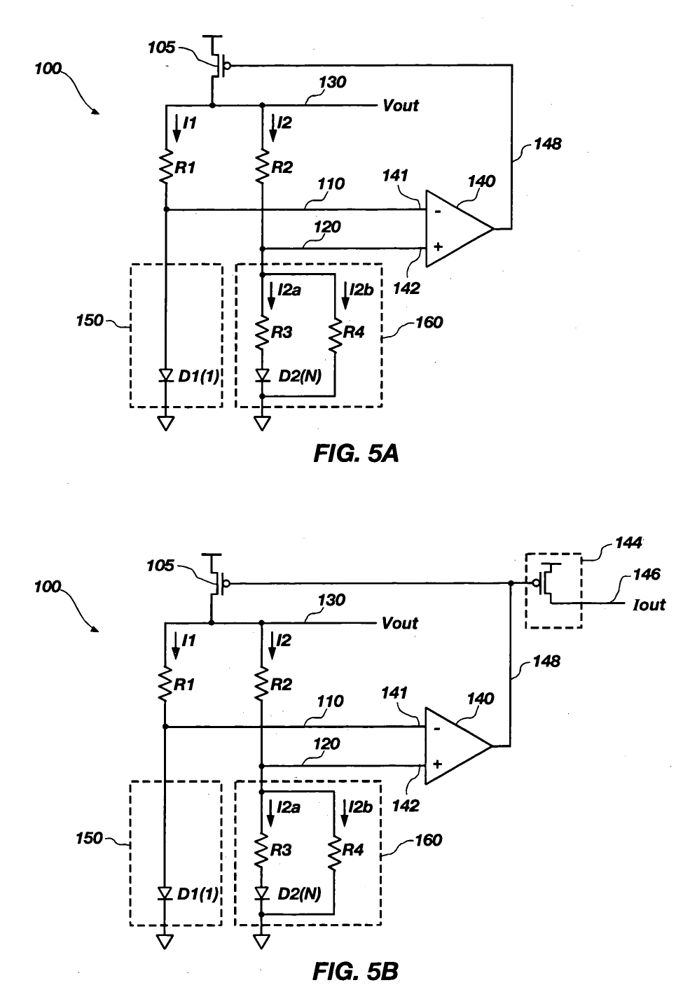

FIG. 5A illustrates an embodiment of the present invention for generating a variable output voltage above the bandgap voltage. The voltage reference circuit 100 includes a current source 105 configured as a p-channel transistor, an amplifier 140, a first voltage generator 150, and a second voltage generator 160. The first voltage generator 150 includes a first P—N junction element D1 and a first resistance element R1. The second voltage generator 160 includes a second P—N junction element D2, a second resistance element R2, a third resistance element R3, and a fourth resistance element R4. The first P—N junction element D1 and second P—N junction element D2 are configured with junction areas of relative size such that the first P—N junction element D1 has a junction area with a relative size of one, and the second P—N junction element D2 has a junction area that is N times the size of the first P—N junction element D1.

In general, embodiments of the invention are described that generate a desired voltage on an output signal 130. However, those of ordinary skill in the art will appreciate that some applications may require a current reference rather than, or in addition to, a voltage reference. In those applications, an embodiment shown in FIG. 5B may be used. The embodiment of FIG. 5B is similar to the embodiment of FIG. 5A with the inclusion of an optional output current source 144, which may be used to generate an output current signal 146 that is proportional to the voltage on the output signal 130. In the embodiment of FIG. 5B, a simple p-channel transistor is used for generating the output current signal 146. Those of ordinary skill in the art, will also recognize that other current sources are possible and encompassed by the scope of the invention.

Similarly, those of ordinary skill in the art will recognize that the current source 105 may be configured with a variety of circuit elements, such as, for example an n-channel transistor in a source follower configuration. Also, the resistance elements may be formed using various circuit elements and connections to generate a relatively constant resistance value. Some possible resistor implementations include, for example, discrete resistors, a length of N+ doped region as a resistor element, a length of P+ doped region as a resistor element, a length of polysilicon as a resistor element, an n-channel transistor connected such that it operates in the saturation region, and a p-channel transistor connected such that it operates in the saturation region.

As stated earlier, two diodes of different sizes, but with the same emitter current, will have different current densities and, as a result, slightly different voltage drops across the P—N junction. Similarly, because different current densities result in different voltage drops, the two diodes may also be selected to have the same size (i.e., N=1) and the circuit designed to provide different currents through the two diodes. Furthermore, P—N junctions have a negative temperature coefficient wherein changes in the voltage drop across the P—N junction are inversely related to changes in temperature. In other words, as temperature rises, the voltage drop across a P—N junction falls. For example, for silicon, V_{be} is inversely related to temperature changes at about −2.2 mV/° C. Thus, the difference in current density creates a slightly different voltage drop across the first P—N junction element D1 relative to the second P—N junction element D2.

In operation, the feedback on the amplifier 140 operates to develop a steady state wherein an inverting input node 141 (also referred to as a first input) and a non-inverting input node 142 (also referred to as a second input) are maintained at substantially the same voltage potential. If the inputs are not at the same potential, the amplifier 140 acts to reduce or increase the voltage on a feedback node 148 (also referred to as a comparison result). In turn, the voltage on the feedback node 148 will increase or decrease the current through the current source 105.

In analyzing the circuit of FIG. 5A, it can be shown, and those of ordinary skill in the art will recognize, that the voltage across a diode may be expressed as approximately,

$$VD = ( \frac{kT}{q} ) ln ( \frac{I}{Is * A} ) \qquad ( 1 )$$

where k is Boltzmann's constant, which equals about 1.3806×10−23 Joules/° K, q is electron charge, which equals about 1.602×10−19 Coulombs, T is absolute temperature in ° Kelvin, I is the forward current through the diode, Is represents a reverse saturation current of the diode, and A is the area of the P—N junction. The term kT/q is often referred to as the thermal voltage (VT). Thus, at room temperature of 300° K, VT equals about 26 millivolts.

As stated earlier, the feedback on the amplifier 140 operates to move the voltage of the first voltage signal 110 and the voltage of the second voltage signal 120 to substantially the same voltage. Thus,
V_{be1}=V_{R3}+V_{be2} (2)

VR3 may also be referred to as ΔV_{be} because it represents the difference in voltage drop between the first P—N junction element D1 and the second P—N junction element D2. Substituting in the diode equation, ΔV_{be} may be represented as,

$$\begin{matrix}Δ {V}_{be} = {V}_{be 1} - {V}_{be 2} \\ = ( \frac{kT}{q} ) ln ( \frac{I 1}{Is * A 1} ) - ( \frac{kT}{q} ) ln ( \frac{I 2}{Is * A 2} ) \\ = ( \frac{kT}{q} ) ln ( \frac{I 1 * A 2}{I 2 * A 1} )\end{matrix} \qquad ( 3 )$$

If resistance elements R1 and R2 are selected to have the same resistance, and at steady state the voltage at the first voltage signal 110 is substantially equal to the voltage at the second voltage signal 120, then the current II will be substantially equal to the current 12, and equation 2 may be written as,

$$Δ {V}_{be} = \frac{kT}{q} ln ( N ) = VT ln ( N ) \qquad ( 4 )$$

where N equals the ratio of P—N junction area between the first P—N junction element D1 and the second P—N junction element D2.

The voltage on the output signal 130 is the sum of the voltage drops across the first resistance element R1 and the first P—N junction element D1, which may be written as,
Vₒᵤₜ=V_{be1}+V_{R1} (5)

The current 12 equals the sum of the sub-current 12a (also referred to as a first portion) and the sub-current 12b (also referred to as a second portion), as represented by the equation,

$$I 2 = I 2 a + I 2 b = \frac{Δ {V}_{be}}{R 3} + \frac{V 2}{R 4} \qquad ( 6 )$$

where V2 indicates the voltage at the second voltage signal 120. However, in a steady state, V2 equals V_{be1} so equation 6 may be written as,

$$I 2 = I 2 a + I 2 b = \frac{Δ {V}_{be}}{R 3} + \frac{{V}_{be 1}}{R 4} \qquad ( 7 )$$

Therefore, the voltage drop across the second resistance element R2 is.

$${V}_{R 2} = R 2 * I 2 = ( \frac{R 2}{R 3} ) Δ {V}_{be} + ( \frac{R 2}{R 4} ) {V}_{be 1} \qquad ( 8 )$$

In a steady state, V_{R1} equals V_{R2}. As a result, Vout from equation 5 may be written as,

$$Vout = {V}_{be 1} + ( \frac{R 2}{R 3} ) Δ {V}_{be} + ( \frac{R 2}{R 4} ) {V}_{be 1} \qquad ( 9 )$$

From this equation, parameters sets may be defined that meet a voltage on the output signal 130 that is greater than the bandgap voltage of about 1.25 volts, while still maintaining substantial temperature independence wherein the change in voltage of the output signal 130 relative to a change in temperature is substantially near zero. In other words,

$$\frac{ⅆ Vout}{ⅆ T} \approx 0$$

For example, in the case of R1=R2=240 Kohms, R3=15 Kohms, R4=400 Kohms, and N=8, a Vout of about 2.2V can be obtained.

In contrast, analyzing the prior art circuit of FIG. 1, yields an equation for the current 12, which may be represented as,

$$I 2 = \frac{Δ {V}_{be}}{{R}_{36}} \qquad ( 10 )$$

Therefore, the voltage drop across the resistance element 22 is,

$${V}_{22} = {R}_{22} * I 2 = ( \frac{{R}_{32}}{{R}_{36}} ) Δ {V}_{be} \qquad ( 11 )$$

Thus, in a steady state and with V₂₂ equal to V₃₂, the Vout of FIG. 1 may be written as,

$$Vout = {V}_{be 1} + ( \frac{{R}_{32}}{{R}_{36}} ) Δ {V}_{be} \qquad ( 12 )$$

In other words, Vout for the prior art circuit of FIG. 1 may be written as Vout=V_{be1}+A*V_{be}. Whereas, in embodiments of the present invention, Vout may be written as Vout=V_{be1}+B*ΔV_{be}+C*V_{be1}.

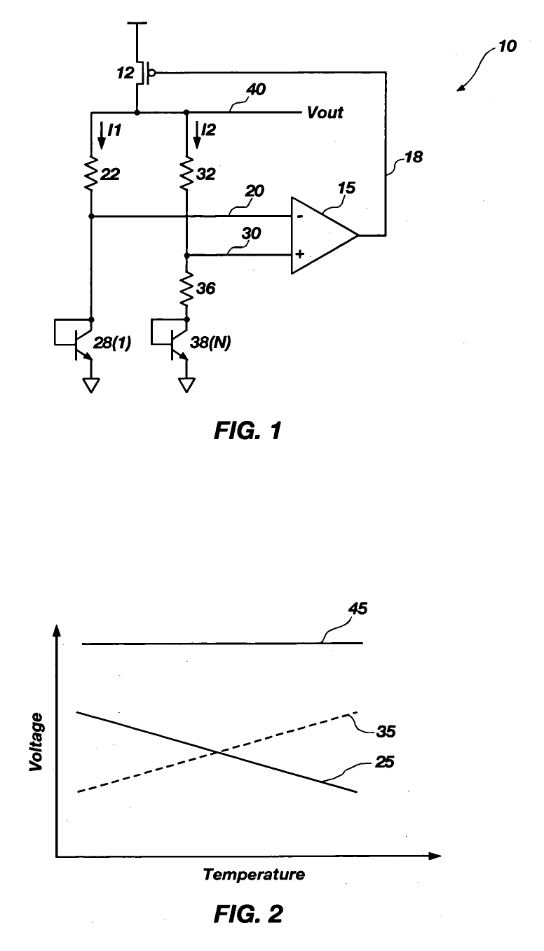

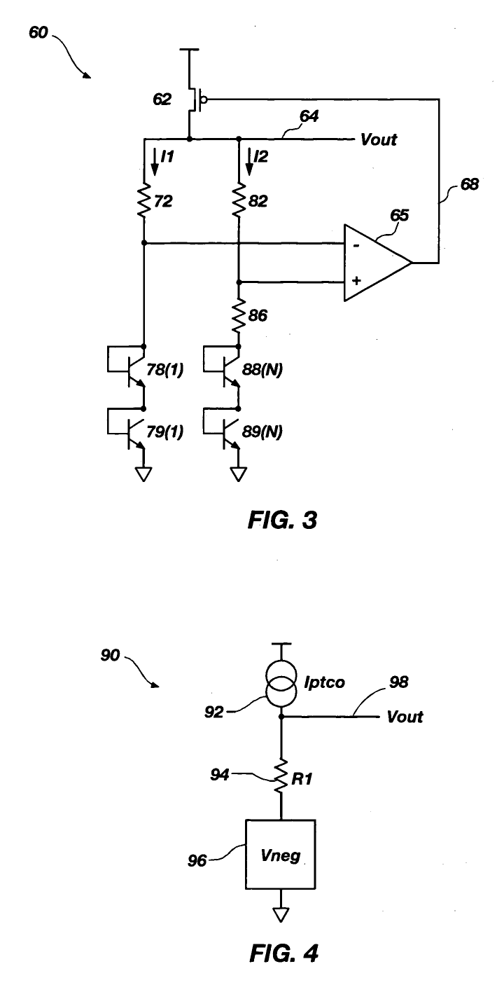

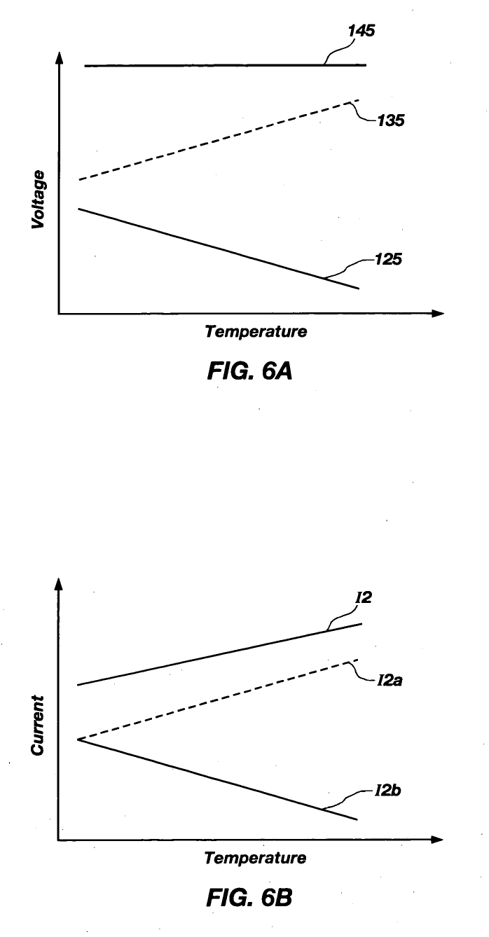

Equation 9 may be illustrated graphically by FIG. 6A. In FIG. 6A, line 125 illustrates the negative temperature coefficient of the first P—N junction element D1 (i.e., the first voltage signal 110 and, in a steady state, the second voltage signal 120). Line 135 illustrates the voltage difference across R2, which is equal to the resistance of R2 times Iptco (i.e., R2*Iptco). Line 135 includes a slope similar to that of FIG. 2, namely the (R2/R3)*ΔV_{be} term from equation 9. However, in FIG. 6A, line 135 includes a y-intercept higher than that of FIG. 2. The y-intercept may be represented by the portion of equation 9 defined as (R2/R4)*V_{be1}. Line 145 represents the Vout voltage, which is a sum of line 125 and line 135.

Similarly, the current 12 may be represented graphically as in FIG. 6B. Current I2 is illustrated as the sum of sub-current I2a and sub-current I2b. It can be seen that current I2a is directly related to temperature change due to the ΔV_{be} term in equation 7. Similarly, sub-current I2b is inversely related to temperature change due to the V_{be1} term in equation 7. As a result, it can be seen how the current generator 92 (shown in FIG. 4) can create a reference current Iptco with a positive temperature coefficient from the I2a portion of current I2 and an additional offset current from the I2b portion of current I2.

In operation of the voltage reference circuit of FIG. 5A, the feedback on the amplifier 140 operates to develop a steady state wherein the inverting input node 141 and the non-inverting input node 142 are maintained at substantially the same voltage potential. If the inputs are not at the same potential, the amplifier 140 acts to reduce or increase the voltage on the feedback node 148. In turn, the voltage on the feedback node 148 will increase or decrease the current through the current source 105. Thus, for a circuit wherein the first resistance element R1 and the second resistance element R2 have the same value, the voltage drop across the first P—N junction element D1 is equal to the voltage drop across the circuit combination of the second P—N junction element D2, the third resistance element R3, and the fourth resistance element R4. As stated earlier, due to the negative temperature coefficient for diodes, as temperature rises, the V_{be} of the first P—N junction element D1 decreases at a higher rate than the V_{be} decrease of the second P—N junction element D2. Consequently, to keep the feedback loop in a steady state, the ΔV_{be} across the third resistance element R3, has a direct temperature correlation (i.e., voltage change increases as temperature increases).

However, with embodiments of the present invention, the fourth resistance element R4 provides a shunting current path to ground around the third resistance element R3 and the second P—N junction element D2. This operates to increase the current I2, resulting in a larger voltage drop across the second resistance element R2. In other words, when the proper resistance ratios are selected, V2 may be held substantially near the thermal voltage by adjusting the ratio of R3 relative to R2. However, at the same time, adjusting R4 relative to R2 may generate a larger voltage drop across the first resistance element R1 and the second resistance element R2 to raise the reference voltage on the output signal 130. Different resistance ratios may be selected to modify the reference voltage to different values while still maintaining a substantial independence from source voltage and a substantial independence from temperature changes.

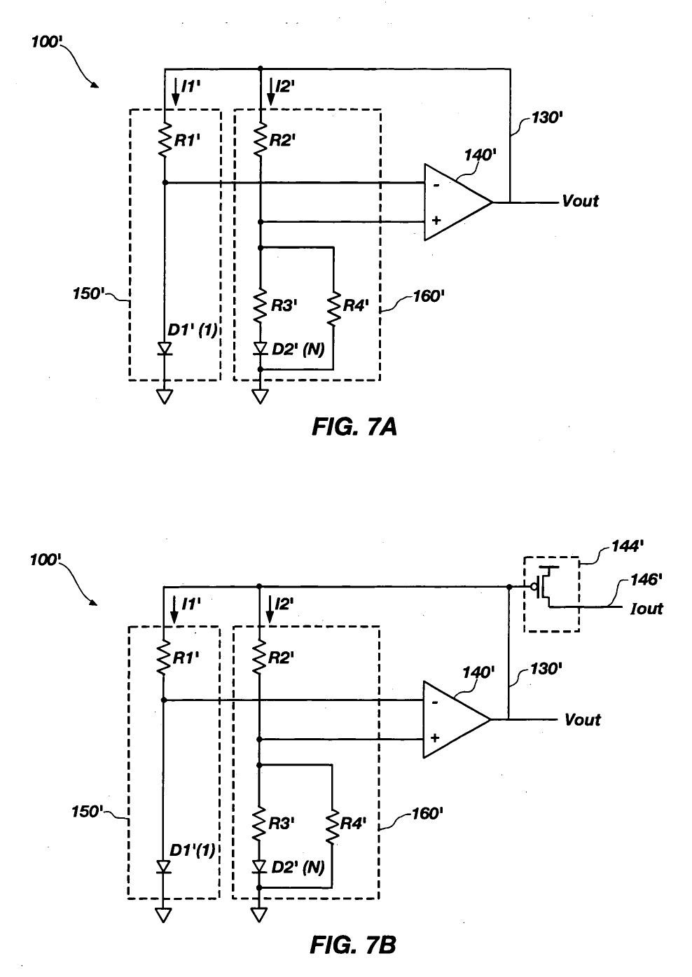

FIG. 7A illustrates another embodiment of the present invention for generating a variable output voltage above the bandgap voltage. The voltage reference circuit 100 includes an amplifier 140′, a first resistance element R1′, a second resistance element R2′, a first voltage generator 150′, and a second voltage generator 160′. The first voltage generator 150′ comprises a first P—N junction element D1′. The second voltage generator 160′ includes a second P—N junction element D2′, a third resistance element R3′, and a fourth resistance element R4′. The first P—N junction element D1′ and second P—N junction element D2′ are configured with junction areas of relative size such that the first P—N junction element D1′ has a junction area with a relative size of one, and the second P—N junction element D2′ has a junction area that is N times the size of the first P—N junction element D1.

The embodiment of FIG. 7A operates similar to the embodiment of FIG. 5A except that the output of the amplifier 140′ acts directly as a current source for currents I1′ and I2′, rather than buffering the output of the amplifier 140′ through a current source. In addition, the output of the amplifier 140′ acts as the output signal 130′. In operation, the explanation for the embodiment of FIG. 5A is equally applicable to the embodiment of FIG. 7A.

In those applications where a current reference may be desired, an embodiment shown in FIG. 7B may be used. The embodiment of FIG. 7B is similar to the embodiment of FIG. 7A with the inclusion of an optional output current source 144′, which may be used to generate an output current signal 146′ that is proportional to the voltage on the output signal 130′.

Embodiments of the present invention, while mostly described in relation to semiconductor memories, are applicable to many semiconductor devices. By way of example, any semiconductor device requiring a voltage reference above the bandgap voltage, which is substantially temperature independent, such as sense amplifiers, input signal level sensors, phase locked loops, and delay locked loops, may use the present invention.

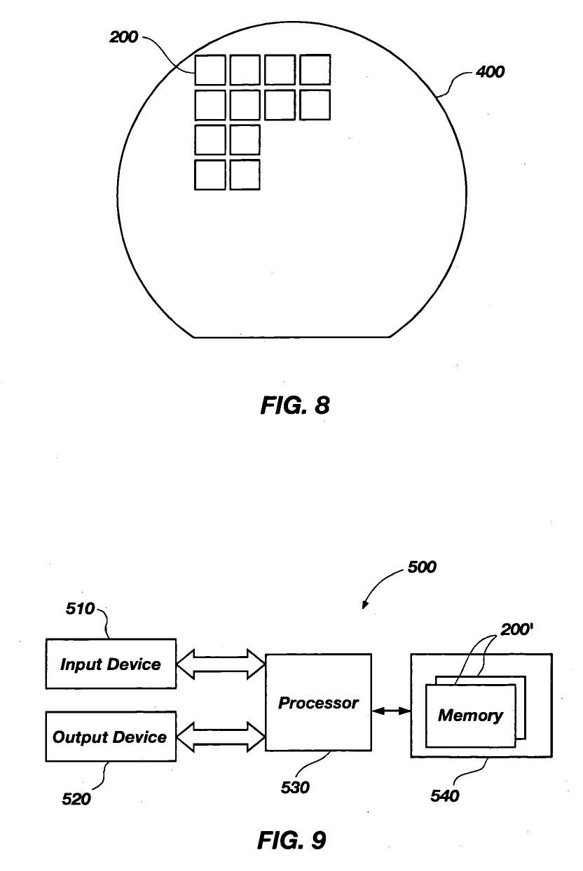

As shown in FIG. 8, a semiconductor wafer 400, in accordance with the present invention, includes a plurality of semiconductor devices 200 incorporating at least one embodiment of the voltage reference circuits 100 described herein. Of course, it should be understood that the semiconductor devices 200 may be fabricated on substrates other than a silicon wafer, such as, for example, a Silicon On Insulator (SOI) substrate, a Silicon On Glass (SOG) substrate, and a Silicon On Sapphire (SOS) substrate.

As shown in FIG. 9, an electronic system 500, in accordance with the present invention, comprises an input device 510, an output device 520, a processor 530, and a memory device 540. The memory device 540 comprises at least one semiconductor memory 200′ incorporating at least one embodiment of the voltage reference circuits 100 described herein in a DRAM device. It should be understood that the semiconductor memory 200′ might comprise a wide variety of devices other than a DRAM, including, for example, Static RAM (SRAM) devices, and Flash memory devices.

While the present invention has been described herein with respect to certain preferred embodiments, those of ordinary skill in the art will recognize and appreciate that it is not so limited. Rather, many additions, deletions, and modifications to the preferred embodiments may be made without departing from the scope of the invention as hereinafter claimed. In addition, features from one embodiment may be combined with features of another embodiment while still being encompassed within the scope of the invention as contemplated by the inventors.

1. A voltage reference circuit, comprising:
a first voltage generator configured for generating a first voltage signal having a negative temperature coefficient;
a current generator configured for supplying a reference current having a positive temperature coefficient and an offset current, wherein the reference current is related to a voltage of the first voltage signal;
a first resistance element operably coupled between the first voltage generator and the current generator;
an output signal operably coupled to the current generator, wherein the output signal comprises a voltage that is a voltage offset above a bandgap voltage and substantially independent of a temperature change.

2. The voltage reference circuit of claim 1, wherein the first voltage generator comprises a first P—N junction element operably coupled in a forward bias direction between the first resistance element and a ground.

3. The voltage reference circuit of claim 2, wherein the first P—N junction element comprises a device selected from the group consisting of a diode, a diode connected bipolar transistor, and a diode connected CMOS transistor.

4. The voltage reference circuit of claim 1, wherein the current generator comprises:
a current source configured for generating the reference current;
a second resistance element operably coupled between the current source and a second voltage signal;
a third resistance element operably coupled to the second voltage signal;
a fourth resistance element operably coupled between the second voltage signal and a ground;
a second P—N junction element operably coupled in series with the third resistance element in a forward bias direction between the third resistance element and the ground; and
an amplifier configured for comparing the first voltage signal to the second voltage signal to generate a comparison result, wherein the comparison result modifies the reference current with a current change related to the comparison result.

5. The voltage reference circuit of claim 4, wherein the second P—N junction element comprises a device selected from the group consisting of a diode, a diode connected bipolar transistor, and a diode connected CMOS transistor.

6. The voltage reference circuit of claim 4, wherein the current source comprises a p-channel transistor having a source operably coupled to a voltage source, a gate operably coupled to the comparison result, and a drain operably coupled to the output signal.

7. The voltage reference circuit of claim 4, wherein the current source comprises the comparison result of the amplifier.

8. The voltage reference circuit of claim 1, further comprising an output current source operably coupled to the output signal and configured to generate an output current signal proportional to the voltage of the output signal.

9. A voltage reference circuit, comprising:
an amplifier having a first input, a second input, and a comparison result;
a current source configured for sourcing a current related to a voltage of the comparison result, wherein an output of the current source is configured as an output signal;
a first resistance element operably coupled between the output signal and the first input;
a first P—N junction element operably coupled in a forward bias direction between the first input and a ground;
a second resistance element operably coupled between the output signal and the second input;
a third resistance element operably coupled to the second input;
a second P—N junction element operably coupled in series with the third resistance element in a forward bias direction between the third resistance element and the ground; and
a fourth resistance element operably coupled between the second input and the ground.

10. The voltage reference circuit of claim 9, wherein the current source comprises a p-channel transistor having a source operably coupled to a voltage source, a gate operably coupled to the comparison result, and a drain operably coupled to the output signal.

11. The voltage reference circuit of claim 9, wherein the first P—N junction element comprises a device selected from the group consisting of a diode, a diode connected bipolar transistor, and a diode connected CMOS transistor.

12. The voltage reference circuit of claim 9, wherein the second P—N junction element comprises a device selected from the group consisting of a diode, a diode connected bipolar transistor, and a diode connected CMOS transistor.

13. The voltage reference circuit of claim 9, further comprising an output current source operably coupled to the output signal and configured to generate an output current signal proportional to the voltage of the output signal.

14. A voltage reference circuit, comprising:
an amplifier having a first input, a second input, and a comparison result configured as an output signal;
a first resistance element operably coupled between the output signal and the first input;
a first P—N junction element operably coupled in a forward bias direction between the first input and a ground;
a second resistance element operably coupled between the output signal and the second input;
a third resistance element operably coupled to the second input;
a second P—N junction element operably coupled in series with the third resistance element in a forward bias direction between the third resistance element and the ground; and
a fourth resistance element operably coupled between the second input and the ground.

15. The voltage reference circuit of claim 14, wherein the first P—N junction element comprises a device selected from the group consisting of a diode, a diode connected bipolar transistor, and a diode connected CMOS transistor.

16. The voltage reference circuit of claim 14, wherein the second P—N junction element comprises a device selected from the group consisting of a diode, a diode connected bipolar transistor, and a diode connected CMOS transistor.

17. The voltage reference circuit of claim 14, further comprising an output current source operably coupled to the output signal and configured to generate an output current signal proportional to the voltage of the output signal.

18. A method of generating a reference voltage, comprising:
generating a reference current;
generating a first voltage signal related to a first portion of the reference current, wherein the first voltage is inversely related to a temperature change;
generating a second voltage signal related to a second portion of the reference current, wherein the second voltage is directly related to the temperature change;
comparing the first voltage signal to the second voltage signal to generate a comparison result;
modifying the reference current with a current change related to the comparison result; and
generating an output voltage related to the second voltage, wherein the output voltage is a voltage offset above a bandgap voltage and substantially independent of the temperature change.

19. The method of claim 18, wherein generating the reference current is performed by controlling the current through a p-channel transistor with a voltage related to the comparison result.

20. The method of claim 18, wherein generating the first voltage signal comprises creating a first voltage drop across a first P—N junction element.

21. The method of claim 18, wherein generating the second voltage signal comprises creating a second voltage drop across a resistance element operably coupled in parallel with a series combination of a another resistance element and a second P—N junction element.

22. The method of claim 18, further comprising generating an output current signal proportional to the output voltage.

23. A semiconductor device including at least one voltage reference circuit, comprising:
a first voltage generator configured for generating a first voltage signal having a negative temperature coefficient;
a current generator configured for supplying a reference current having a positive temperature coefficient and an offset current, wherein the reference current is related to a voltage of the first voltage signal;
a first resistance element operably coupled between the first voltage generator and the current generator;
an output signal operably coupled to the current generator, wherein the output signal comprises a voltage that is a voltage offset above a bandgap voltage and substantially independent of a temperature change.

24. The semiconductor device of claim 23, wherein the first voltage generator comprises a first P—N junction element operably coupled in a forward bias direction between the first resistance element and a ground.

25. The semiconductor device of claim 24, wherein the first P—N junction element comprises a device selected from the group consisting of a diode, a diode connected bipolar transistor, and a diode connected CMOS transistor.

26. The semiconductor device of claim 23, wherein the current generator comprises:
a current source configured for generating the reference current;
a second resistance element operably coupled between the current source and a second voltage signal;
a third resistance element operably coupled to the second voltage signal;
a fourth resistance element operably coupled between the second voltage signal and a ground;
a second P—N junction element operably coupled in series with the third resistance element in a forward bias direction between the third resistance element and the ground; and
an amplifier configured for comparing the first voltage signal to the second voltage signal to generate a comparison result, wherein the comparison result modifies the reference current with a current change related to the comparison result.

27. The semiconductor device of claim 26, wherein the second P—N junction element comprises a device selected from the group consisting of a diode, a diode connected bipolar transistor, and a diode connected CMOS transistor.

28. The semiconductor device of claim 26, wherein the current source comprises a p-channel transistor having a source operably coupled to a voltage source, a gate operably coupled to the comparison result, and a drain operably coupled to the output signal.

29. The semiconductor device of claim 26, wherein the current source comprises the comparison result of the amplifier.

30. The semiconductor device of claim 23, further comprising an output current source operably coupled to the output signal and configured to generate an output current signal proportional to the voltage of the output signal.

31. A semiconductor wafer, comprising:
at least one semiconductor device including at least one voltage reference circuit, comprising:
a first voltage generator configured for generating a first voltage signal having a negative temperature coefficient;
a current generator configured for supplying a reference current having a positive temperature coefficient and an offset current, wherein the reference current is related to a voltage of the first voltage signal;
a first resistance element operably coupled between the first voltage generator and the current generator;
an output signal operably coupled to the current generator, wherein the output signal comprises a voltage that is a voltage offset above a bandgap voltage and substantially independent of a temperature change.

32. The semiconductor wafer of claim 31, wherein the first voltage generator comprises a first P—N junction element operably coupled in a forward bias direction between the first resistance element and a ground.

33. The semiconductor wafer of claim 32, wherein the first P—N junction element comprises a device selected from the group consisting of a diode, a diode connected bipolar transistor, and a diode connected CMOS transistor.

34. The semiconductor wafer of claim 31, wherein the current generator comprises:
a current source configured for generating the reference current;
a second resistance element operably coupled between the current source and a second voltage signal;
a third resistance element operably coupled to the second voltage signal;
a fourth resistance element operably coupled between the second voltage signal and a ground;
a second P—N junction element operably coupled in series with the third resistance element in a forward bias direction between the third resistance element and the ground; and
an amplifier configured for comparing the first voltage signal to the second voltage signal to generate a comparison result, wherein the comparison result modifies the reference current with a current change related to the comparison result.

35. The semiconductor wafer of claim 34, wherein the second P—N junction element comprises a device selected from the group consisting of a diode, a diode connected bipolar transistor, and a diode connected CMOS transistor.

36. The semiconductor wafer of claim 34, wherein the current source comprises a p-channel transistor having a source operably coupled to a voltage source, a gate operably coupled to the comparison result, and a drain operably coupled to the output signal.

37. The semiconductor wafer of claim 34, wherein the current source comprises the comparison result of the amplifier.

38. The semiconductor wafer of claim 31, further comprising an output current source operably coupled to the output signal and configured to generate an output current signal proportional to the voltage of the output signal.

39. An electronic system, comprising:
at least one input device;
at least one output device;
a processor; and
a memory device comprising, at least one semiconductor memory including at least one voltage reference circuit, comprising:
a first voltage generator configured for generating a first voltage signal having a negative temperature coefficient;
a current generator configured for supplying a reference current having a positive temperature coefficient and an offset current, wherein the reference current is related to a voltage of the first voltage signal;
a first resistance element operably coupled between the first voltage generator and the current generator;
an output signal operably coupled to the current generator, wherein the output signal comprises a voltage that is a voltage offset above a bandgap voltage and substantially independent of a temperature change.

40. The electronic system of claim 39, wherein the first voltage generator comprises a first P—N junction element operably coupled in a forward bias direction between the first resistance element and a ground.

41. The electronic system of claim 40, wherein the first P—N junction element comprises a device selected from the group consisting of a diode, a diode connected bipolar transistor, and a diode connected CMOS transistor.

42. The electronic system of claim 39, wherein the current generator comprises:
a current source configured for generating the reference current;
a second resistance element operably coupled between the current source and a second voltage signal;
a third resistance element operably coupled to the second voltage signal;
a fourth resistance element operably coupled between the second voltage signal and a ground;
a second P—N junction element operably coupled in series with the third resistance element in a forward bias direction between the third resistance element and the ground; and
an amplifier configured for comparing the first voltage signal to the second voltage signal to generate a comparison result, wherein the comparison result modifies the reference current with a current change related to the comparison result.

43. The electronic system of claim 42, wherein the second P—N junction element comprises a device selected from the group consisting of a diode, a diode connected bipolar transistor, and a diode connected CMOS transistor.

44. The electronic system of claim 42, wherein the current source comprises a p-channel transistor having a source operably coupled to a voltage source, a gate operably coupled to the comparison result, and a drain operably coupled to the output signal.

45. The electronic system of claim 42, wherein the current source comprises the comparison result of the amplifier.

46. The electronic system of claim 39, further comprising an output current source operably coupled to the output signal and configured to generate an output current signal proportional to the voltage of the output signal.
